(19) United States
(12) Patent Application Publication
(10) Pub. No.: US 2023/0392545 A1
(43) Pub. Date: Dec. 7, 2023

(54) POWER CONVERSION SYSTEM INCLUDING ENGINE AND HEAT EXCHANGER

(71) Applicant: Claudio FILIPPONE, College Park, MD (US)

(72) Inventor: Claudio FILIPPONE, College Park, MD (US)

(21) Appl. No.: 18/207,136

(22) Filed: Jun. 7, 2023

Related U.S. Application Data
(60) Provisional application No. 63/412,877, filed on Oct. 3, 2022.
(60) Provisional application No. 63/350,017, filed on Jun. 7, 2022.

(51) Int. Cl. F02C 1/05; F02C 1/10

(52) U.S. Cl. CPC F02C 1/05; F02C 1/10; F05D 2220/60; F05D 2220/76

(57) ABSTRACT

Various exemplary embodiments of a power system for converting thermal energy from a heat source to electricity are disclosed. In one exemplary embodiment, the power conversion system includes a turbomachinery engine based on fossil-fueled aeroderivative or heavy-duty gas turbine engines coupled to electric generators retrofitted with a heat exchanger thermally coupled to a carbon-free heat source to convert thermal energy from the carbon-free heat source to the air flowing through the turbomachinery of a compressor and expanding through the turbomachinery of an expander coupled to a mechanical shaft driving the compressor turbomachinery and an electric generator.

### CROSS REFERENCE TO RELATED APPLICATIONS

This application claims priority to U.S. Provisional Patent Application No. 63/350,017, filed on Jun. 7, 2022, and U.S. Provisional Patent Application No. 63/412,877, filed on Oct. 3, 2022. The entire content of the above-referenced applications is incorporated herein by reference.

### TECHNICAL FIELD

The present disclosure relates generally to a system, and in more specifically, to a power conversion system including an engine and a heat exchanger.

### BACKGROUND

A pollutant-free heat source may be represented by nuclear reactors, solar thermal accumulators, geothermal systems, and high-temperature processes generating high-temperature working fluids from various industrial processes. When a nuclear reactor is considered as a pollutant-free heat source, the nuclear reactor generally includes a nuclear core for producing thermal energy during normal operation. In some configurations the nuclear reactor is coupled to a Rankine vapor cycle for the conversion of thermal energy into electricity. In other configurations the reactor is coupled to a Brayton gas cycle for the conversion of thermal energy into electricity. In yet other configurations, the nuclear core thermal power can be partitioned to support only process heat applications, or to supply process heat and electricity. Another form of energy from a nuclear reactor is represented by the decay heat. After shutdown, the nuclear core still produces thermal energy as a result of decay heat. The amount of decay heat after shutdown is generally proportional to the power generation history and power density of the nuclear core. To avoid overheating of the nuclear core after shutdown, decay heat energy must be transferred from the nuclear core by redundant heat transfer mechanisms, which are generally supplied by decay heat removal systems external to the nuclear core. These heat transfer systems may require complex piping networks to connect the pressure vessel containing the nuclear core to heat exchangers generally located externally with respect to the pressure vessel. Further, the coolant circulating between the nuclear core and the heat exchangers may be either actively circulated by electrically driven pumps and/or blowers or passively circulated via gravity-driven natural circulation mechanisms.

Independent of their sizes, modern nuclear reactors rely on redundant decay heat removal systems that are generally combinations of passive and active systems. These systems are formed by components that are generally external to the pressure vessel containing the nuclear core and, therefore, result in a complex system of redundant piping, valves, and heat exchangers for passive systems with the addition of pumps/blowers and motive power managed and monitored by control systems and cabling.

Some advanced reactor designs include melt-resistant nuclear cores equipped with various passive heat transfer mechanisms. While providing highly reliable heat source, however, these nuclear cores may be sealed within their pressurized vessels and, therefore, conventional heat removal systems with complex networks of balance-of-plant components may not be suitable for use with these advanced reactor designs.

All nuclear reactors produce thermal energy that can be transferred by heat transfer means to the components executing the conversion from thermal-energy to electricity, whether the nuclear design involves, minimizes or eliminates the equipment forming the balance-of-pant.

The turbomachinery forming aeroderivative and heavy-duty gas turbines represent power conversion components that generally convert fossil fuels energy into electricity by mixing and burning a mixture formed by air and fossil-fuels. These power systems, or engines, utilize combustion chambers designed to mix and ignite the mixture formed by the oxygen, contained in environmental air, with fossil fuels (e.g., in gaseous, liquid or particulate form) to generate high-temperature exhaust gases that expand through the expander turbomachinery forming a single or multistage power turbine to convert thermal energy to mechanical torque or thermodynamic work at the turbomachinery shaft, for final, direct or indirect (e.g., via gear box) conversion to electricity by means of an electric generator. Commercial engines represented by aeroderivative and heavy-duty gas turbines generally do not include a heat exchanger dedicated to transfer thermal-energy from a heat source not sourced in the combustion of air-fossil-fuels mixtures. A nuclear reactor may represent a pollutant-free heat source coupled to a heat exchanger that transfers thermal energy from the nuclear core to the environmental air compressed by these engines for heating and expansion of the air through the power turbine equipping the aeroderivative- and heavy-duty gas-turbine-generators.

Overall, independently of the power rating, type of nuclear fuels, working fluids and other heat transfer mechanisms employed to transfer energy from the nuclear core to the power conversion components and to cool-down the nuclear core during decay heat removal, there is a need for transferring high-grade (high-temperature) thermal energy via heat exchanger to the compressed air normally supplied by the compressor of engines represented by aeroderivative and gas-turbines dedicated to the production of electricity, for heating and expansion of the compressed air through the turbomachinery components that convert thermal energy to mechanical torque and mechanical energy to electrical energy.

Some nuclear reactor configurations include intermediary heat exchangers to transfer all or a portion of the thermal energy produced by the nuclear fuel to a working fluid that transports the core thermal energy to different utilizations, generally referred to as “process heat.”

### SUMMARY

Various exemplary embodiments of the present disclosure may provide a thermal-to-electric power conversion system by retrofitting commercial engines formed by aeroderivative and heavy-duty gas-turbines coupled to electric generators by augmenting, by-passing, or entirely replacing the combustors normally equipping these engines with heat exchangers disposed within the engine housing, or outside of the engine housing, wherein the heat source may be represented by a nuclear heat source, wherein a working fluid circulating between the heat source and the heat exchanger, transfer thermal energy to compressed air compressed by a compressor mechanically coupled to a shaft, an expander and a generator. To heat up the compressed air for this hot air to expand through the expander and convert thermal energy to mechanical energy transferred to the expander shaft, and further converting this mechanical energy into electricity by an electric generator coupled to the shaft. Another objective of the present disclosure is to effectively and efficiently remove heat from a nuclear core with minimum and optimized balance-of-plant. By utilizing one or multiple intermediate heat exchangers, the present invention enables safe transfer of the thermal energy produced by the heat source (e.g., a nuclear core), to power conversion components for the conversion of thermal energy into torque and electricity. In one configuration, the intermediate heat exchangers of the present invention enable safe transfer of the thermal energy produced by a nuclear core to turbomachinery components wherein a selected working fluid is compressed, heated up by heat transfer with a working fluid utilized by the nuclear reactor, to expand and produce thermodynamic work and electricity in a closed-loop. In another configuration, the intermediate heat exchangers of the present invention enable safe transfer of the thermal energy produced by a nuclear core to natural, dried or filtered environmental air, normally flowing at the inlet of turbomachinery components forming engines represented by aeroderivative and heavy-duty gas turbines coupled to electric generators, for the air to heat up through heat transfer with a working fluid utilized by the nuclear reactor, without mixing with the working fluid utilized by the nuclear reactor, wherein the air expand in the turbomachinery expander of the engine to produce thermodynamic work and electricity, wherein the air circulates in an open-loop from the engine inlet at atmospheric conditions to the engine outlet venting back to the environment.

To attain the advantages and in accordance with the purpose of the invention, as embodied and broadly described herein, one aspect of the invention may provide a power conversion system for converting thermal energy from a heat source to electricity. The power conversion system may operate in a closed-loop configuration and include a substantially sealed chamber having an inner shroud having an inlet and an outlet and defining an internal passageway between the inlet and the outlet through which a working fluid passes. The sealed chamber may also include an outer shroud substantially surrounding the inner shroud, such that the working fluid exiting the outlet of the inner shroud returns to the inlet of the inner shroud in a closed-loop via a return passageway formed between an external surface of the inner shroud and an internal surface of the outer shroud. The power conversion system may further include a source heat exchanger disposed in the internal passageway of the inner shroud, the source heat exchanger being configured to at least partially receive a heat transmitting element associated with the heat source external to the substantially sealed chamber, the source heat exchanger being further configured to transfer heat energy from the heat transmitting element to the working fluid passing through the source heat exchanger.

In another exemplary aspect, the power conversion system may also include a compressor disposed adjacent the inlet of the inner shroud and configured to transfer energy from the compressor to the working fluid, and an expander disposed adjacent the outlet of the inner shroud and configured to extract heat energy from the working fluid. In some exemplary aspects, the compressor and the expander may be disposed inside the outer shroud.

According to another exemplary aspect, a power conversion system for converting thermal energy from a heat source to electricity may include a shroud having an inlet and an outlet and defining an internal passageway between the inlet and the outlet through which a working fluid passes. The power conversion system may also include a source heat exchanger disposed in the internal passageway of the shroud, the source heat exchanger being thermally coupled to a heat transmitting element of the heat source and being configured to transfer heat energy from the heat transmitting element to the working fluid passing through the source heat exchanger.

The power conversion system may also include a compressor disposed adjacent the inlet of the shroud and configured to transfer energy from the compressor to the working fluid, and an expander disposed adjacent the outlet of the shroud and configured to extract heat energy from the working fluid. In one exemplary aspect, the compressor and the expander may be disposed inside the shroud.

According to another exemplary aspect, the power conversion system may include an inlet conduit extending from a source of the working fluid to an inlet of the compressor, and a discharge conduit extending from an outlet of the expander to the source of the working fluid.

According to another exemplary aspect, the power conversion system may include an inlet conduit extending from a source of air as the working fluid to an inlet of the compressor, through a retrofitted aeroderivative coupled to an electric generator or a heavy-duty gas turbine generator, wherein the combustor or combustors is/are retrofitted to include compressed air heated by heat exchangers to transfer thermal energy from the nuclear core, transferred by a primary or secondary working fluid, to the air working fluid, for the air to heat-up and expand through the power turbine of the aeroderivative or heavy-duty gas turbine generator. In another exemplary aspect, the combustor or combustors normally equipping aeroderivative and heavy-duty gas turbine generators, are entirely replaced by heat exchangers to transfer thermal energy from the nuclear core to the air flowing through the turbomachinery of these power conversion components, wherein the heat exchangers may be configured for operation directly within the housing of the turbomachinery or heavy-duty gas turbine-generator, or indirectly with the heat exchangers configured for operations outside of the housing that encloses the aeroderivative or heavy-duty gas turbine-generator components.

The exemplary aspects of the power conversion system equipped with heat exchangers to directly or indirectly transfer thermal energy from the nuclear core to the compressed air flowing through the aeroderivative and heavy-duty gas turbine components enable electric power production through aeroderivative and heavy-duty gas turbine generators without mixing and igniting mixtures formed by air and fossil fuels, and by utilizing the air as the working fluid heated up by nuclear power without producing pollutants typically resulting from the combustion of fossil fuels, therefore reaching the goal of total decarbonization for these electric power generators.

According to various embodiments, the present disclosure provides a thermal-to-electric conversion system formed by a heat source coupled to a heat exchanger retrofitted with engines equipped with the turbomachinery driving electric generators. In one configuration, thermal-energy is transferred to a retrofitted air-breathing fossil-fueled engine to increase the temperature of the air which is mixed with fossil-fuel to ignite and expand the resulting exhaust gases through the turbomachinery forming commercial aeroderivative-generator and heavy-duty gas-turbine-generator engines dedicated to the production of electricity to reduce the carbon-emission from these engines. In another configuration, thermal energy is transferred to a retrofitted engine, wherein hot air expands through the turbomachinery of the retrofitted engine without utilizing fossil-fuels, and the retrofitted engine may be represented by modified commercial aeroderivative-generator or heavy-duty gas-turbine-generator units converting thermal energy to electricity with zero carbon emissions.

In some configurations, the heat source utilized to heat up the air through a heat exchanger is represented by a nuclear reactor. In another configuration the heat source may be represented by solar-thermal energy, or geothermal energy.

In particular, various embodiments of the present disclosure relate to power conversion systems and methods of retrofitting fossil-fueled engines (e.g., aeroderivative, heavy-duty gas-turbines) for use as electric generators with reduced carbon emission or zero carbon emission.

The present disclosure relates generally to the utilization of heat sources such as nuclear reactors, solar thermal sources, geothermal sources or high-temperature process heat to reduce pollutant emissions from fossil-fuels conversion into electricity by combustion. In some configurations, the present disclosure supplies pollutant-free thermal power to air-breathing engines such as aeroderivative and heavy-duty gas turbines (aeroderivative-turbines) by retrofitting or replacing the fossil-fueled combustors equipping these engines with heat exchangers thermally coupled to a pollutant-free and carbon-free heat source by transferring thermal energy to the compressed air produced by the compressor equipping aeroderivative-turbine-generators and expand the resulting hot air in the turbomachinery representing the expander for conversion of thermal energy into mechanical energy at the shaft of the expander, and further converting the mechanical energy at the shaft to electric power by means of an electric generator coupled to the shaft driven by the expander turbomachinery. In particular, various embodiments of the present disclosure relate to thermal-to-electric power conversion systems and methods for use in power generation, with thermal energy produced by various pollutant-free heat sources and electricity produced by retrofitted aeroderivative engines and heavy-duty gas turbines engines coupled to electric generators.

Additional objects and advantages of the invention will be set forth in part in the description that follows, and in part will be obvious from the description, or may be learned by practice of the invention.

It is to be understood that both the foregoing summary description and the following detailed description are exemplary and explanatory only and are not restrictive of the invention.

### BRIEF DESCRIPTION OF THE DRAWINGS

The accompanying drawings, which are incorporated in and constitute a part of this specification, illustrate several embodiments of the invention and together with the description, serve to explain the principles of the disclosed invention.

FIG. 1 is a functional schematic of a power conversion system disposed inside a transport container, according to an exemplary embodiment of the present disclosure.

FIG. 2 is a functional schematic of the power conversion system of FIG. 1, illustrating its main components in more detail.

FIG. 3 is a functional schematic of a sealed chamber having a source heat exchanger configured to receive heating elements of a nuclear reactor core, according to one exemplary embodiment.

FIG. 4 is an exploded view of area A shown in FIG. 3, illustrating an exemplary configuration of a heat transmitting element of a nuclear reactor core and a heat receiving portion of a source heat exchanger.

FIG. 5 is a functional schematic of a power conversion system, according to another exemplary embodiment, consistent with the present disclosure.

FIG. 6 is a functional schematic of a power conversion system, according to still another exemplary embodiment, consistent with the present disclosure.

FIG. 7 is a cross-sectional view of a power conversion system, according to still another exemplary embodiment, consistent with the present disclosure.

FIG. 8 is a cross-sectional view of a power conversion system, according to still another exemplary embodiment, consistent with the present disclosure.

FIG. 9 is a functional schematic of a power conversion system, according to still another exemplary embodiment, consistent with the present disclosure with heat exchangers transferring thermal energy from a nuclear core with working fluid circulating in a closed loop to compressed environmental air in an open loop configuration.

FIG. 10 is a functional schematic of a power conversion system of FIG. 9, according to still another exemplary embodiment, consistent with the present disclosure with an engine represented by a turbine-generator system configured to convert thermal energy from a heat source to electricity by means of an independent expander coupled to an electric generator.

FIG. 11 is a functional schematic of a power conversion system, according to still another exemplary embodiment, consistent with the present disclosure, illustrating a configuration employing a different type of reactor wherein the working fluid circulating in the closed loop is a gaseous working fluid transferring thermal energy from a nuclear core to air by means of one or multiple heat exchanger.

FIG. 12 is a partial functional symmetric schematic view of an engine formed by the turbomachinery of commercial aeroderivative and heavy-duty gas turbine coupled to electric generators and equipped with combustors developing radially and axially with respect to the shaft of the engine and extruding from the engine housing with a fossil-fuel injection system for the combustion of air and fossil fuel mixture to convert combustion thermal energy to mechanical torque directly or indirectly utilized to produce electrical power.

FIG. 12a is a schematic functional cross-sectional view of an engine represented by the turbomachinery of commercial aeroderivative and heavy duty gas illustrating the positioning of combustors and other components to support the injection of fossil fuels and mixing of fossil fuels with compressed air to generate high-temperature exhaust gases and convert the thermal energy in the exhaust gases by expansion through expanders coupled to electric generators.

FIG. 13 is a schematic functional view of a retrofitted engine wherein the combustor, normally disposed within the engine housing, are replaced by a heat exchanger transferring thermal energy from a heat source represented by a nuclear reactor to the compressed air for expansion of this air with increased energy content through the expander mechanically coupled to a shaft.

### DETAILED DESCRIPTIONS

Reference will now be made in detail to the exemplary embodiments of the invention, examples of which are illustrated in the accompanying drawings. Wherever possible, the same reference numbers will be used throughout the drawings to refer to the same or like parts.

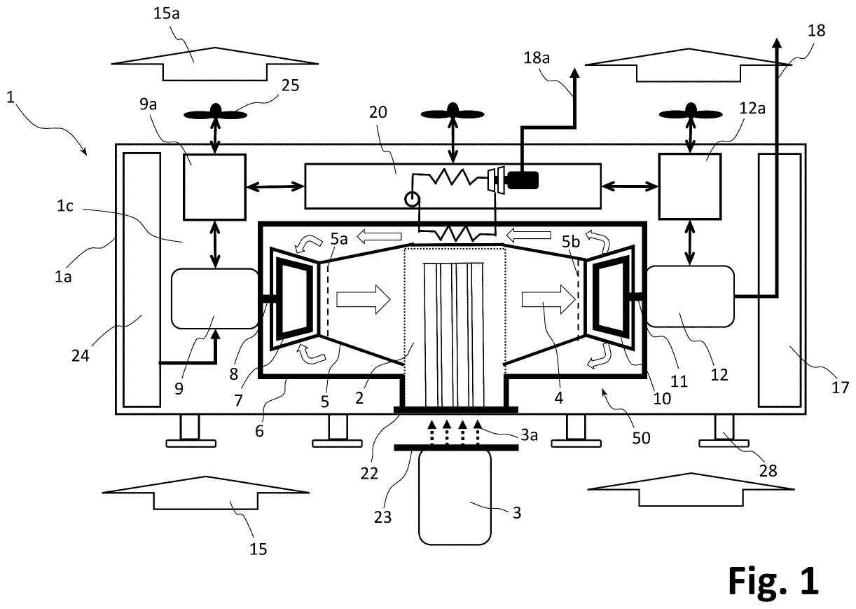

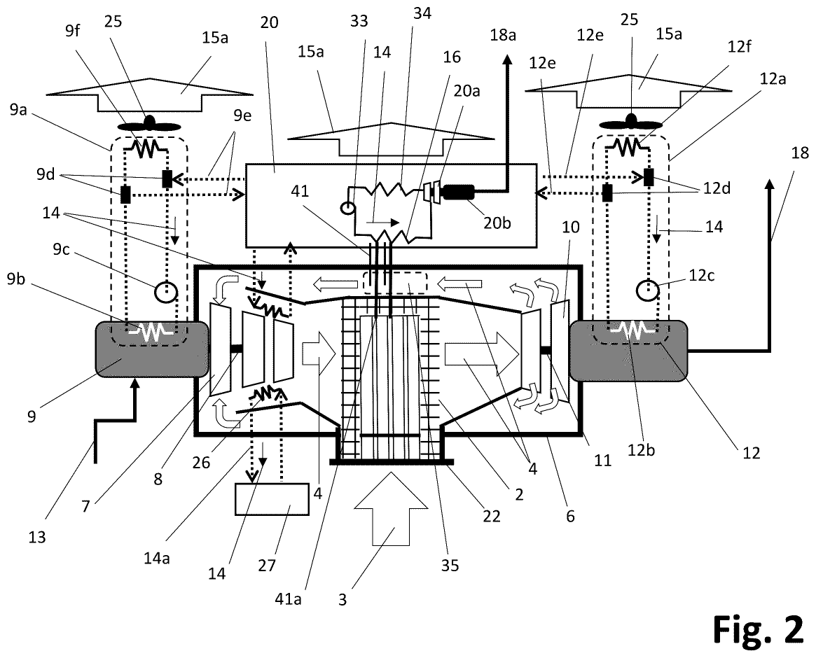

FIGS. 1 and 2 illustrate a power conversion system 1, according to one exemplary embodiment of the present disclosure. The power conversion system 1 may also be referred to as a power system 1 or a system 1. As shown in FIG. 1, power conversion system 1, consistent with the present disclosure, may be sufficiently compact to fit inside a transport container 1a (e.g., intermodal container), thereby making it easily transportable by any conventional transportation means, such as, for example, trucks, freight rails, and ships. Transport container 1a may include a plurality of pads 28 located at its bottom surface to provide a stable support platform from the ground. Pads 28 may be adjustable in height and may include a vibration dampening mechanism. Pads 28 also thermally separate the bottom portions of transport container 1a from the ground, or platform to be placed under the transport container 1a, to thermally insulate the container 1a bottom portions from heating said ground or platform.

Power conversion system 1 may include a closed-loop primary system for converting thermal energy from a nuclear reactor core to electricity. The thermal energy from a nuclear reactor core is depicted as a heat source 3 in FIG. 1, which may represent a heat transmitting portion of a nuclear reactor. The heat transmitting portion of the nuclear reactor may be a portion of the nuclear reactor core designed to transmit heat directly therefrom (e.g., nuclear fuel rods) or a part of any intermediary structure for transferring heat from the nuclear reactor core (e.g., heat pipes extending from a reactor core to remove heat from the reactor core, or a working fluid thermally coupled to the reactor core). As will be described in more detail, power conversion system 1 of the present disclosure may be configured to interface with the heat transmitting portion of the nuclear reactor to remove heat therefrom and convert it into electricity. It should be understood, however, that power conversion system 1 of the present disclosure may be configured for other various types of thermal energy. For example, heat source 3 may alternatively or additionally include any other type of heat generating source, such as, for example, combustion heat from fossil fuel, or geothermal heat, or solar heat, or waste thermal energy from industrial processes.

In the exemplary embodiment shown in FIG. 1, heat source 3 (e.g., a nuclear reactor core) may be disposed underground, such that power conversion system 1 of the present disclosure may be transported to the site and positioned directly above heat source 3. It should be understood that heat source 3 may be positioned above ground, and power conversion system 1 may be readily re-configured to accommodate different locations and configurations of heat source 3. The heat source 3 may also be referred to as a nuclear reactor heat source, although other types of heat source other than a nuclear reactor may also be used as the heat source 3.

Referring to FIG. 1, power conversion system 1 may include a substantially sealed chamber 50 having an inner shroud 5 and an outer shroud 6 substantially surrounding inner shroud 5. Sealed chamber 50 may enable pressurization of the closed-loop for working fluid 4 to circulate, without mixing with fluids potentially operating with heat source 3. Sealed chamber 50 may also include a source heat exchanger 2 inside inner shroud 5. Source heat exchanger 2 may be configured to at least partially receive a heat transmitting element 3a of heat source 3, such that heat from heat transmitting element 3a may be transferred to working fluid 4 inside source heat exchanger 2. The portion of source heat exchanger 2 that receives heat transmitting element 3a may include one or more recesses or pockets (depending on the configuration of heat transmitting element 3a) extending inwardly from a first flange 22 of sealed chamber 50, which is outside of the pressure boundary of sealed chamber 50 in which working fluid 4 circulates. Therefore, although heat transmitting element 3a is thermally coupled to working fluid 4 inside sealed chamber 50, it may not be in direct contact with working fluid 4.

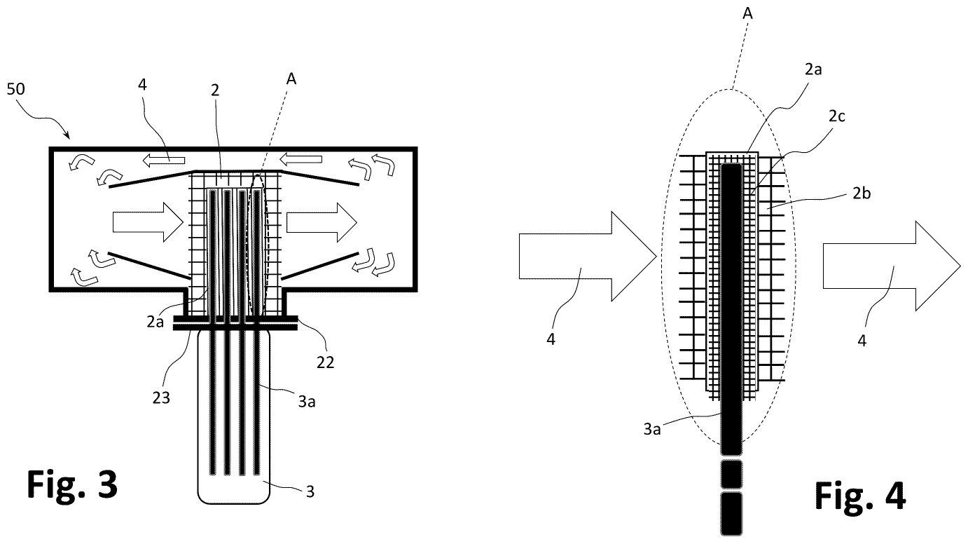

In the exemplary embodiment shown in FIGS. 3 and 4, heat transmitting element 3a may include a plurality of heat pipes 3a extending from heat source 3 (e.g., a nuclear reactor core, or nuclear fuel elements forming a nuclear core) and source heat exchanger 2 may include a plurality of recesses 2a extending from first flange 22 and configured to receive the plurality of heat pipes 3a, or could be represented by a heat exchanger thermally coupled to the heat source. Source heat exchanger 2 may define a plurality of heating channels 2b through which working fluid 4 may pass. As working fluid 4 passes through heating channels 2b, heat from heat pipes 3a may be transferred to working fluid 4.

Heat source 3 may include a second flange 23 configured to thermally and hydraulically couple heat source 3 to first flange 22, while allowing thermal expansion and contraction therebetween. First flange 22 and second flange 23 can also be configured to dampen vibrations generated by the operations of power conversion system 1. In some exemplary embodiments, at least one of first flange 22 and second flange 23 may include a flexible member that may also enhance sealing the gap between first flange 22 and second flange 23.

Power conversion system 1 may include an electronic controller 24, configured to control and regulate thermodynamic and electrical parameters of the Brayton cycle and the Rankine cycle of transportable power conversion system 1. The operational characteristics of controller 24 will be described in connection with the descriptions of various related components of power conversion system 1.

Each recess 2a of source heat exchanger 2 may be slightly larger than heat pipe 3a to form a gap between the outer surface of heat pipe 3a and the inner surface of recess 2a. The gap or clearance may allow heat pipe 3a and recess 2a to expand and contract without inducing mechanical stress. Recess 2a may contain a suitable heat transfer medium 2c in the gap, which may enhance heat transfer between heat pipe 3 and recess 2a. Heat transfer medium 2c may also ensure that heat pipe 3 and recess 2a remain in thermal contact during expansion and contraction.

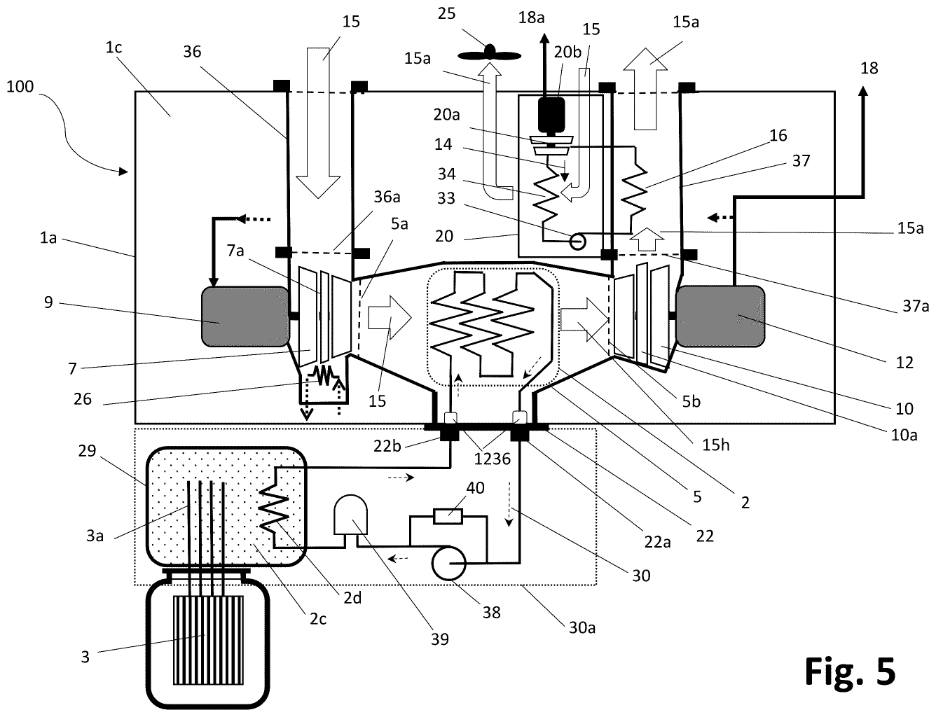

As shown in FIGS. 1 and 5, inner shroud 5 may include an inlet 5a and an outlet 5b and define an internal passageway between inlet 5a and outlet 5b through which working fluid 4 can pass. Source heat exchanger 2 may be disposed inside the internal passageway of inner shroud 5 between inlet 5a and outlet 5b to exchange heat energy with heat transmitting element 3a of heat source 3. As will be described in more detail herein, when working fluid 4 flows through source heat exchanger 2, heat energy from heat source 3 is transferred to working fluid 4 without working fluid 4 physically mixing with any working fluid of heat source 3. Working fluid 4 may include any suitable working fluid with adequate thermal-physical properties to operate under a Brayton- or Rankine-cycle thermodynamic configuration.

Power conversion system 1 may further include a compressor 7 disposed adjacent inlet 5a of inner shroud 5 and an expander 10 disposed adjacent outlet 5b of inner shroud 5. Compressor 7 may include turbomachinery components, such as, for example, multi-stage stator nozzles and rotary turbines or positive displacement components, configured to transfer energy from compressor 7 to working fluid 4 by compressing and/or pumping working fluid 4. Expander 10 may include turbomachinery components, such as, for example, multi-stage stator nozzles and rotary turbines or positive displacement components, configured to extract heat energy from working fluid 4.

Outer shroud 6 may substantially surround inner shroud 5, compressor 7, and expander 10. Outer shroud 6 may define a return passageway between the outer surface of inner shroud 5 and the inner surface of outer shroud 6 wherein working fluid 4 circulates in a closed-loop configuration. The return passageway may be configured to guide working fluid 4 exiting expander 10 to recirculate back to compressor 7. Outer shroud 6 may also be configured to structurally support the turbomachinery components of compressor 7 and expander 10.

Outer shroud 6 may also provide mechanical coupling and support for electric motor 9 and electric generator 12, while defining a sealed flange (not shown) enabling rotation of the rotary components of compressor 7 and expander 10. In some exemplary embodiments, outer shroud 6 may be configured to provide mechanically support for, and define fluid dynamic pathways of, stators 7a, 10a (FIG. 5) of rotary turbomachinery components. Similarly, inner shroud 5 may be configured to provide mechanical support for, and define fluid dynamic pathways of, stators 7a and 10a of the rotary turbomachinery components for working fluid 4 to be compresses by compressor 7.

Before entering inlet 5a of inner shroud 5, working fluid 4 is compressed and/or pumped by compressor 7. Working fluid 4 then enters inlet 5a of inner shroud 5, passes through heating channels 2b of source heat exchanger 2 to extract heat energy from one or more heat transmitting elements 3a, and exits outlet 5b of inner shroud 5. Working fluid 4 exiting outlet 5a of inner shroud 5 enters expander 10 and expands through the turbomachinery components of expander 10. Working fluid 4 discharged from expander 10 passes through the return passageway defined by inner shroud 5 and outer shroud 6 and recirculates back to compressor 7.

As shown in FIGS. 1 and 2, compressor 7 may include a motor shaft 8 configured to mechanically couple the rotary components of compressor 7 to an electric motor 9. Compressor 7 is driven by electric motor 9, and electric motor 9 is driven by a portion of the electricity produced by an electric generator 12 conditioned by a conditioner 17. Expander 10 may include a generator shaft 11 configured to mechanically couple the rotary components of expander 10 to electric generator 12. Expander 10 is driven by working fluid 4 flowing from source heat exchanger 2 and exiting inner shroud 5. Electric generator 12 may include power electronic components, such as, for example, IGBT-based inverters, and may produce electricity rectified and conditioned by electronic conditioner 17. Conditioner 17 may also regulate the electricity produced by electric generator 12 to supply the conditioned electricity to a power bus 18 and to electric motor 9. The rotary components of compressor 7 and motor shaft 8 and the rotary components of expander 10 and second rotary components coupled to generator shaft 11 may form distinct turbo-machinery rotary components optimized to pump/compress or expand independently of one another.

In the disclosed exemplary embodiment, electric motor 9 and electric generator 12 may be cooled by a motor cooling circuit 9a (FIG. 2) and a generator cooling circuit 12a, respectively. Motor cooling circuit 9a and generator cooling circuit 12a may use a working fluid 14 different from working fluid 4 of the closed-loop primary system. Working fluid 14 may include a thermal-oil, an organic fluid, or any fluid with adequate thermal-physical properties to operate within the temperature and pressure ranges suitable for the Brayton- and Rankine-cycle components of power conversion system 1.

As best shown in FIG. 2, motor cooling circuit 9a may include a recirculation pump 9c configured to recirculate working fluid 14, a motor heat exchanger 9b configured to receive thermal energy generated by electric motor 9, and a radiator 9f configured to transfer thermal energy from electric motor 9 to the ultimate heat sink. In this exemplary embodiment, motor cooling circuit 9a may include a set of three-way valves 9d to transfer working fluid 14 to a secondary conversion system having components operating under a Rankine cycle (hereinafter referred to as Rankine engine 20) by hydraulic tubing 9e.

Similarly, generator cooling circuit 12a may include a recirculation pump 12c configured to recirculate working fluid 14, a generator heat exchanger 12b configured to receive thermal energy generated by electric generator 12, and a radiator 12f configured to transfer thermal energy from electric generator 12 to the ultimate heat sink. In this exemplary embodiment, generator cooling circuit 12a may include a set of three-way valves 12d configured to regulate the mass flow rate of working fluid 14 flowing to and from Rankine engine 20 via hydraulic tubing 12e.

Three-way valves 9d of motor cooling circuit 9a and three-way valves 12d of generator cooling circuit 12a may be controlled by electronic computerized controller 24. The working fluid circulating through motor cooling circuit 9a and generator cooling circuit 12a may be different than working fluid 14. Any fluid with suitable thermal-physical properties for Rankine engine 20 can be used.

Rankine engine 20 may include a recuperator 16, a heat exchanger configured to transfer thermal energy from working fluid 4 to working fluid 14. Ranking engine 20 may also include a pump 33 configured to pressurize working fluid 14, a condenser 34 configured to transfer thermal energy from working fluid 14 to the ultimate heat sink (e.g., environmental air), an expander 20a configured to expand working fluid 14 and convert thermal energy into mechanical energy, and a generator 20b coupled to expander 20a and configured to convert mechanical energy from expander 20a into electrical energy through electric bus 18a. Electrical energy from bus 18a may be conditioned by controller 24. Expander 20a may include multi-stage turbomachinery components or positive displacement components.

In one exemplary embodiment, Rankine engine 20 may be thermally coupled to working fluid 4 by positioning at least a portion of recuperator 16 in a return passageway 35 (FIG. 2) between the outer surface of inner shroud 5 and the inner surface of outer shroud 6. Alternatively or additionally, recuperator 16 may be thermally coupled to outer shroud 6. In another exemplary embodiment, recuperator 16 may include a plurality of heat transfer fins 41 for thermally coupling working fluid 4 in return passageway 35 to recuperator 16. Overall, the components of Rankine engine 20 may be thermally coupled to working fluid 4 and thermally and hydraulically coupled to working fluid 14 and discharge thermal energy to the ultimate heat sink. The ultimate heat sink may be environmental air, or water if power conversion system 1 is submerged under water.

In some exemplary embodiments, a portion of recuperator 16 may be thermally coupled to a plurality of extended fins 41a that may extend to source heat exchanger 2, such that recuperator 16 is directly thermally coupled to heat transmitting element 3a. Rankine engine 20 with this exemplary configuration may enable decay heat removal from heat source 3 by transferring decay heat energy to the ultimate heat sink through the recuperator heat exchanger 16.

Rankine engine 20 may be thermally and hydraulically coupled to motor cooling circuit 9a to recover thermal energy generated by electric motor 9 and may regulate, via three-way valves 9d, operational parameters of working fluid 14, such as, for example, pressure, temperature, and mass-flow-rate. Similarly, Rankine engine 20 may also be thermally and hydraulically coupled to generator cooling circuit 12a to recover thermal energy generated by generator 12 and may regulate operational parameters of working fluid 14 via three-way valves 12d.

For configurations where the ultimate heat sink is environmental air 15, one or more passive or active cooling devices 25, such as, for example, cooling fans, may be used to circulate heated air 15a and cool down the heat exchangers of intercooler 26 and recuperator 16. Cooling devices 25 may be regulated by controller 24. In some exemplary embodiments, cooling devices 25 may be positioned to direct environment air 15 to flow upwardly from the bottom to the top to take advantage of buoyancy forces as it changes density proportionally to its temperature. Environment air 15 exchanges thermal energy with condenser 34 and heat transfer surfaces 1c of transportable container 1a.

According to another exemplary embodiment, environment air 15 may flow sideways with respect to transport container 1. In still another exemplary embodiment, environment air may flow into and out from the top portion of transport container 1a.

In some exemplary embodiments, compressor 7 may include an intercooler 26 configured to exchange energy between working fluid 4 and working fluid 14. As shown in FIG. 2, Rankine engine 20 may be thermally coupled to intercooler 26 to recover waste thermal energy generated by compressor 7 by regulating the flow of working fluid 14. In one exemplary embodiment, controller 24 may be configured to control one or more valves 27 to regulate the flow of working fluid 14. Intercooler 26 may use working fluid 14a different from working fluid 14 of Rankine engine 20.

FIG. 5 schematically illustrates a power conversion system 100, according to another exemplary embodiment of the present disclosure. This exemplary embodiment may differ from the exemplary embodiments shown in FIGS. 1 and 2 in that, among other things, power conversion system 100 may employ an open-loop system for converting thermal energy from heat source 3 to electricity. For example, as will be described in more detail herein, power conversion system 100 may utilize an intermediary thermodynamic system 30a for transferring heat energy from heat source 3 to source heat exchanger 2.

As shown in FIG. 5, intermediary thermodynamic system 30a may include an intermediary vessel 29 to which a plurality of heat transmitting elements 3a may extend from heat source 3. Intermediary vessel 29 may be filled with a suitable medium 2c for effectively removing heat from heat transmitting elements 3a. Although not illustrated in detail, intermediary vessel 29 may include a suitable structure for interfacing with heat source 3. For example, intermediary vessel 29 may include an interface structure similar to first flange 22 and second flange 23 of power conversion system 1 shown in FIGS. 1 and 2. In an alternative embodiment, intermediary vessel 29 and heat source 3 may form a unitary pressure boundary in which medium 2c of intermediary vessel 29 mixes with a coolant inside heat source 3.

To transfer the heat from intermediary vessel 29, intermediary thermodynamic system may include an intermediary heat exchanger 2d disposed inside intermediary vessel 29, or thermally coupled to vessel 29. Intermediary thermodynamic system 30a may also include an auxiliary or intermediary pump 38 configured to circulate a working fluid 30, an actuator configured to control the flow of working fluid 30, and a pressurizer 39 configured to maintain pressure of working fluid 30 and/or to accommodate temperature-induced volume changes of working fluid 30. Accordingly, working fluid 30 is configured to transfer thermal energy from intermediary vessel 29 to source heat exchanger 2. Working fluid 30 may include a liquid metal or any other suitable fluid with proper thermal-physical properties. In one exemplary embodiment, working fluid 30 may be the same as working fluid 14. In still another exemplary embodiment, working fluid 30 may be different than working fluid 4.

Power conversion system 100 may include a first flange 22 configured to thermally and hydraulically connect to heat source 3 via intermediary thermodynamic system 30a. First flange 22 may include at least one inlet port 22a and at least one outlet port 22b for hydraulically connecting intermediary heat exchanger 2d to source heat exchanger 2.

As shown in FIG. 5, source heat exchanger 2 may be disposed inside inner shroud 5 that is, in this configuration, exposed to the fluids representing the ultimate heat sink. In other words, inner shroud 5 may define an open internal passageway between inlet 5a and outlet 5b through which a fluid representing the ultimate heat sink (e.g., environment air or another suitable fluid in gaseous or liquid form) may flow. In this exemplary embodiment, power conversion system 100 may include an inlet conduit 36 extending from the ultimate heat sink (e.g., outside of transport container 1a) to a compressor inlet 36a. Similarly, power conversion system 100 may include a discharge conduit 37 extending from an expander outlet 37a to the ultimate heat sink.

Power conversion system 100 may include a recuperator 16 configured to transfer thermal energy from heated working fluid 15a discharged from expander 10 to working fluid 14 circulating in Rankine engine 20. Recuperator 16 may be disposed within, or otherwise thermally coupled to, discharge conduit 37 and, as the heat source of Rankine engine 20, may be configured to extract heat from heated fluid 15a. Various turbomachinery components in power conversion system 100 of FIG. 5 may be similar to those shown and/or described with reference to FIGS. 1 and 2 and, therefore, any detailed description will be omitted herein.

As described above, the open-loop thermodynamic cycle executed by compressor 7 and expander 10 utilizes fluid 15 from the ultimate heat sink. As fluid 15 enters compressor 7 at inlet 36a, it is compressed and then flown into source heat exchanger 2 to remove thermal energy from working fluid 30 of intermediary thermodynamic system 30a. Fluid 15 then expands through expander 10 to convert the thermal energy in heated fluid 15h discharged by expander 10. As hot working fluid 15h is discharged by expander 10 at expander outlet 37a it still contains usable thermal energy to be converted into electrical energy via electrical generator 20b independently of the electrical energy generated by generator 12 and obtained by the expansion of working fluid 15h through expander 10. The waste-heat recovered energy represented by heated fluid 15a flowing through expander outlet 37a and transferring thermal energy to recuperator 16 prior to exiting discharge conduit 37, is converted through the Rankine system 20 into electricity at the electric bus 18a.

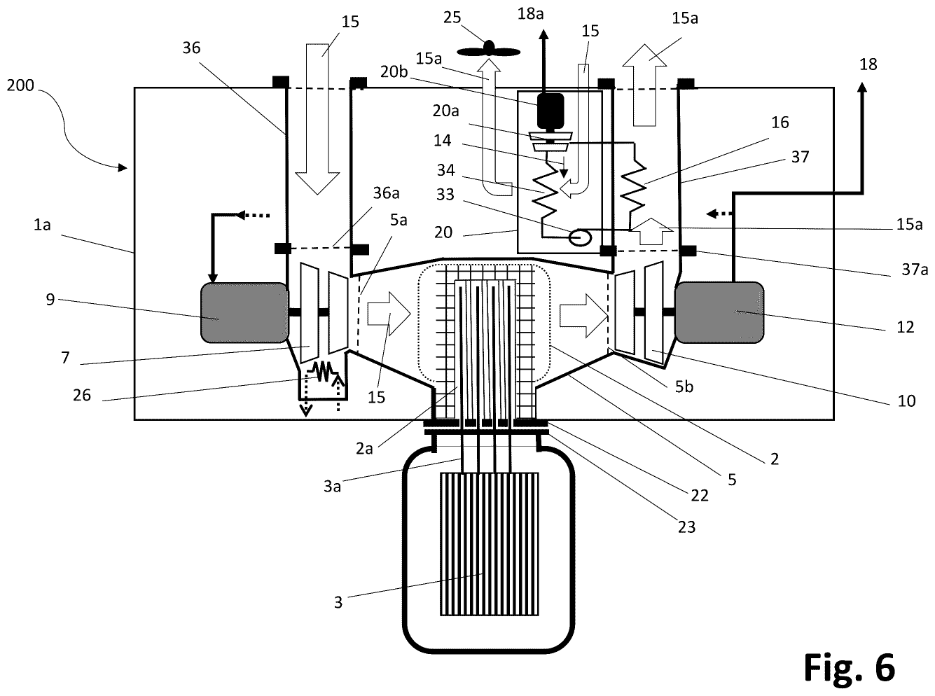

FIG. 6 schematically illustrates a power conversion system 200, according to another exemplary embodiment of the present disclosure. Similar to power conversion system 100 shown in FIG. 5, power conversion system 200 of this exemplary embodiment is an open-loop system utilizing the fluid of the ultimate heat sink to convert thermal energy from heat source 3 to electricity. Power conversion system 200 may differ from power conversion system 100 of FIG. 5 in that, among other things, source heat exchanger 2 can be directly thermally coupled to heat transmitting elements 3a of heat source 3.

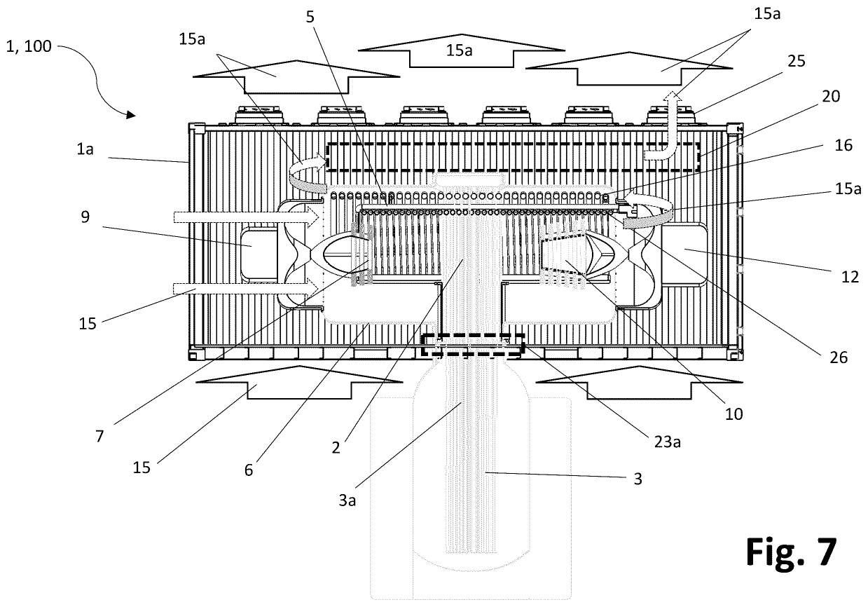

FIG. 7 illustrates a cross-section view of a power conversion system 1, according to still another exemplary embodiment consistent with the present disclosure. In this exemplary embodiment, intercooler 26 may be positioned in the internal passageway of working fluid 4 (for closed-loop configurations) or fluid 15 of ultimate heat sink (for open-loop configurations) inside inner shroud 5, and recuperator 16 may substantially surround outer shroud 6 and intercooler 26. Accordingly, the working fluid used to convert thermal energy from heat source 3 can be either working fluid 4 circulating in a closed-loop configuration or fluid 15 taken from the ultimate heat sink (e.g., the environmental fluid surrounding transport container 1a in an open-loop configuration.

In an open-loop configuration, the environment fluid may be air. Accordingly, air may be suctioned and compressed by compressor 7. The energy added to the air by compressor 7 may be removed by intercooler heat exchanger 26, which may transfer this removed energy to Rankine engine 20 for executing waste heat recovery functions. Overall, in this open-loop configuration the compressed air 15 flows through source heat exchanger 2 to increase its energy content and expands through expander 10. As the air is discharged at the outlet of expander 10, it may exchange energy with recuperator 16, which transfers the recovered energy to Rankine engine 20 for further conversion into electricity. Rankine engine 20 may then reject thermal energy to the ultimate heat sink via one or more cooling device 25.

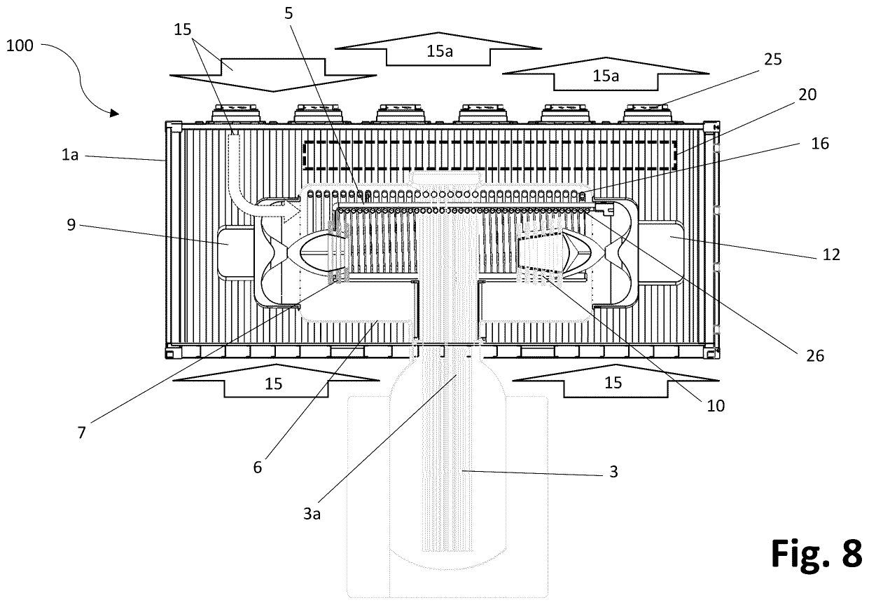

FIG. 8 illustrates a cross-sectional view of a power conversion system 100, according to still another exemplary embodiment. Power conversion system 100 of FIG. 8 may be an open-loop system, where fluid 15 (e.g., environment air) may be drawn into compressor 7 through inlet ports positioned substantially in the upper portion (e.g., on the top surface) of transport container 1a, or at opposite ends of transport container 1a. In another exemplary configuration, Rankine engine 20 may also reject thermal energy to the ultimate heat sink via one or more cooling device 25 positioned on the sides of the transport container 1a.

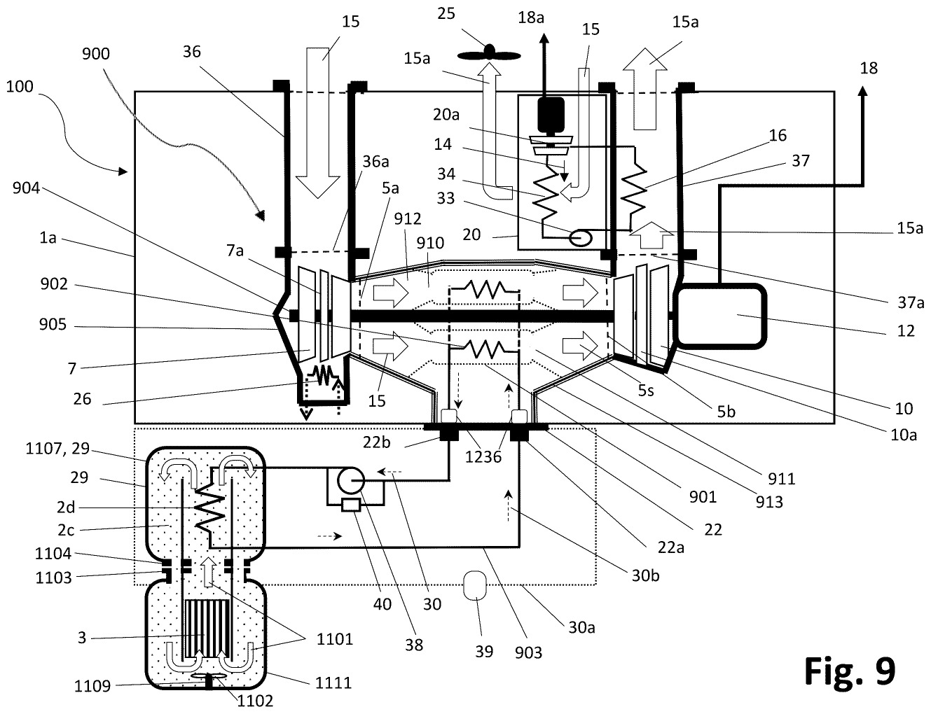

FIG. 9 illustrates a functional diagram with a cross-sectional view of an exemplary power conversion system 100, including an engine 900, which may include a compressor 7, formed by one or multiple stage turbomachinery rotary and stationary turbine components (e.g., turbines 7 and stators 7a), an expander 10, formed by turbomachinery rotary and stationary turbine components (e.g., turbines 10 and stators 10a), coupled together through a rotating shaft 904, wherein an inner spacing 912 of the engine housing 905 defines an engine chamber 913 shown by a triple line following the engine housing contour particularly between the internal inlet indicated by dashed line 5a, and the internal outlet indicated by dashed line 5b. The engine chamber 913 is effectively formed inside the engine housing 905 in the locations substantially central to shaft 904. The engine chamber 913 includes a heat exchanger 901 (e.g., source heat exchanger 2 in FIG. 5), configured to heat up air 15 compressed by compressor 7 and flowing into engine chamber 913 from internal inlet 5a, and as air 15 heats up, as a result of thermal exchange with the working fluid 30b of a heat source operating in an intermediary closed loop 903, it changes its thermodynamic state into “superheated” air 5s, wherein it expands through expander 10. As superheated air 15s expands through expander 10, its thermal energy is converted into mechanical energy manifesting as torque at shaft 904. While air 15s expands it decreases its energy content and exits internal outlet 37a as heated air 15a. The waste energy represented by heated air 15a can be recovered by the waste heat engine 20 described in previous figures. Generator 12 is coupled to expander 10 to further convert the mechanical energy from expander 10 to electric power at power bus 18.

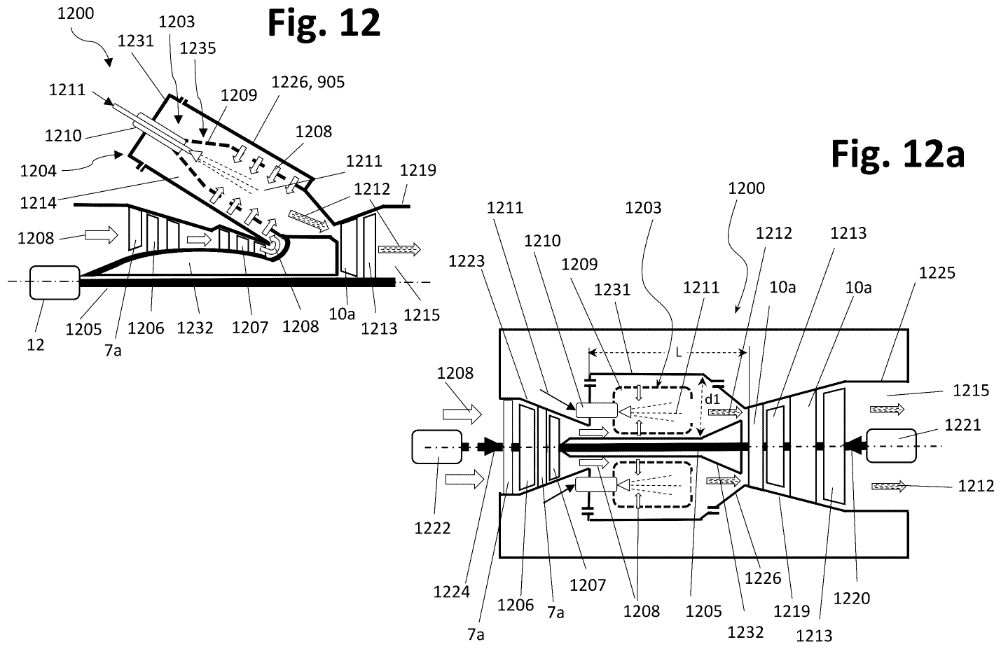

With reference to FIG. 9 the following description shows in greater detail the exemplary embodiment of the power system formed by combining engine 900 with a heat source 3 represented by a nuclear reactor by retrofitting engines based on aeroderivative and gas turbines coupled to electric generators. The retrofit involves, in some configurations, minimally invasive modifications of a few selected components forming commercial engines 1200 shown in FIGS. 12 and 12a as these engines are based on the combustion of fossil-fuel and air mixtures. Other configurations involve more invasive retrofitting by, for example, replacing selected components normally included within the engine housing 913 as indicated in the following description. Accordingly, with reference to FIG. 9, one large-scale or multiple smaller-scale source heat exchangers 901 can be disposed inside the engine chamber 913 normally equipped with combustors components as shown in FIGS. 12 and 12a as engines 1200 normally produce electricity by burning an air and fossil-fuels mixture to produce high-temperature exhaust gases that expand in expander 10. Heat exchanger 901 in FIG. 9, executes the main functions of source heat exchanger 2 described in FIGS. 1 to 8, wherein the power conversion system 100 was configured to convert the thermal energy of a heat source represented by a nuclear reactor into electricity. Heat exchanger 901 is configured to satisfy the dimensional and power transfer requirements dictated by commercial aeroderivative engine chambers 913 (also 1204 in FIGS. 12 and 1231 in FIG. 12a). This approach reduces engine 1200 retrofitting invasiveness. The type, size, and materials of the source heat exchanger 901 satisfy commercial engine 1200 dimensional requirements, these depends on engines power rating, operating temperature, working fluid chemical reactivity (e.g., to address materials corrosion, erosion embrittlement and overall aging aspects), pressure drop, and other constraints. Accordingly, heat exchanger 901 may be formed by tubing, conduits, or channels formed by materials that can withstand the operating environment developing within engine chamber 913. For example, heat exchanger 901 may be represented by a tube and shell heat exchanger, or a printed heat circuit heat exchanger, wherein heat transfer channels may be etched in a thermally conductive diffusion bonded metal block to form a compact heat exchanger shaped to fit within engine chamber 913.

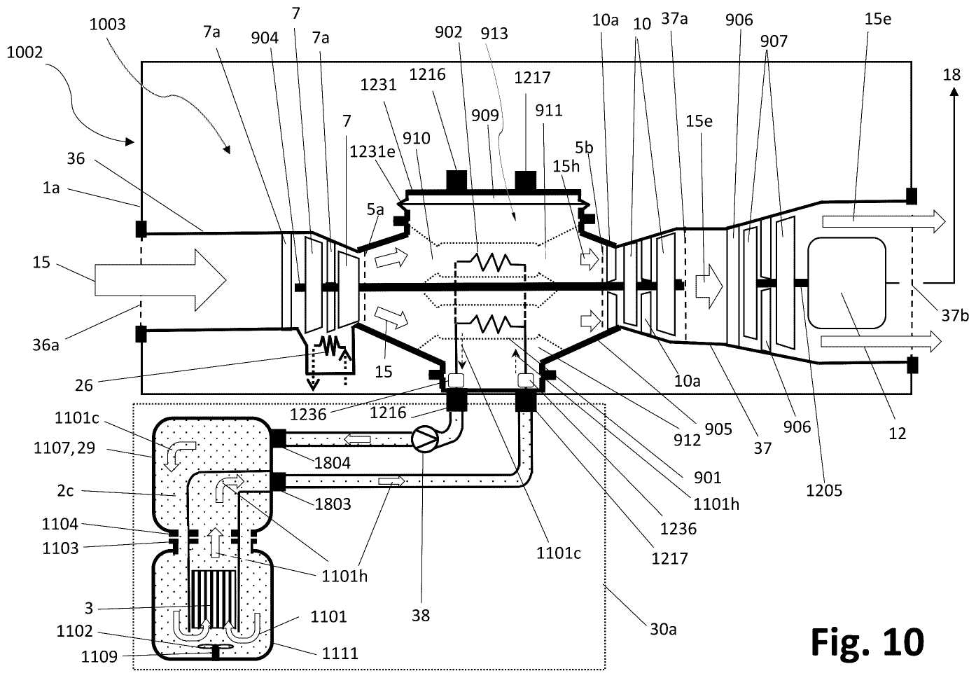

Commercial engines 1200 (FIGS. 12 and 12a), based on aeroderivative turbine-generators or heavy-duty gas turbine-generators, are generally characterized as open-loop air-breathing combustion systems. The combustors, normally equipping these engines are devices that utilize the compressed air from compressor 7, mix it with fossil fuels in gaseous, liquid or particulate form and ignite the resulting air-fuel mixture to convert the thermal energy of the combustion products into mechanical torque at the turbomachinery shaft 904. Torque from shaft 904 is then transferred directly to generator 12 for conversion into electric power. In another configuration, torque from turbomachinery shaft 904 is indirectly converted into mechanical energy by a gear system mechanically coupled to generator 12. In another configuration, a second expander coupled to a generator through a second shaft, independent of shaft 904 shown in FIG. 9, is utilized to convert the thermal energy rejected by the first expander into electricity. This configuration is described in FIG. 10. Referencing to heat exchanger 901 in FIG. 9 and adopting as example a “tube-and-shell” type of heat exchanger, air 15 flows through the internal inlet 36a formed by the engine housing 905, and after compression by compressor 7 flows inside engine chamber 913 and enters heat exchanger air inlet 910. The dashed line surrounding outer surfaces 902 of heat exchanger 901 defines an inner portion of engine chamber 913, wherein air 15 flows at a pressure driven by compressor 7 and heats up by thermal coupling with heat exchanger outer surfaces 902, on the shell-side of heat exchanger 901, and exits this internal portion of the engine chamber 913 at outlet 911 as superheated air 5s. On the tube side of heat exchanger 901, working fluid of the intermediary closed loop 903, flows at a pressure and mass flow rate driven by pump 38. Accordingly, on the shell side of heat exchanger 901, the tubing external surfaces 902 of the tube-and-shell type of heat exchanger are thermally coupled to the air 15 operating in an open-loop configuration of engine 900, while the working fluid circulating internally to the tubing of the tube-and-shell type of heat exchanger, operate in a closed loop configuration. For increased compressor 7 efficiency, an intercooler heat exchanger 26 is configured to cool down air 15 as it is compressed by circulating a cooling working fluid through the intercooler heat exchanger 26. As it will be shown in FIG. 10, the air inlet and outlet 36a and 37a respectively shown in FIG. 9, can be reoriented to be aligned in the engine 900 axial direction as this is also the configuration of commercial engines as shown in FIGS. 12 and 12a.

FIG. 10 illustrates a configuration of power system 1002 whose working principle of engine 1003 are similar to those described in FIG. 9 for engine 900. Engine 1003 is coupled to a heat source 3 represented by a nuclear reactor. Working fluid 1101 circulates through a closed-loop including heat exchanger 901 and is configured in a liquid form (e.g., molten salt, liquid lead reactor typology). Accordingly, working fluid 1101 enters the core 3 at the bottom of reactor pressure vessel 1111 as a result of pump 1102 driven by motor 1109. Relatively cold working fluid 1101 flows through core 3 and heats up while circulating outside of pressure vessel 1107 hydraulically coupled to reactor pressure vessel 1111. Hot working fluid 1101h inlets heat exchanger 901, included within inner space 912, through hydraulic ports 1236, wherein it transfers thermal energy to the compressed air 15 flowing through engine housing 905, and exits heat exchanger 901 hydraulic port 1236 through the outlet port 1216 interfacing with engine housing 905 as cold working fluid 1101c driven by pump 38 back into the top portion of pressure vessel 1107, and flows to the bottom of reactor pressure vessel 1111, thus resetting the cycle of the closed-loop portion of the intermediary thermodynamic system 30a. With respect to the open loop side of the power system 1002 in FIG. 10, air 15 after compression from compressor 7 enters engine chamber 913 included within the central portion of housing 905 (thicker lines shown in FIG. 10) and flows at inlet 910 through heat exchanger 901 and undergoes heat transfer with surfaces 902 of heat exchanger 901 and exits the engine chamber 913 at exit 911 as hot air 15h. Air 15h continues to flow through internal outlet 5b and undergoes a first expansion through expander 10, which is coupled to shaft 904, thus converting thermal energy to mechanical energy rotating shaft 904. The discrimination from the functioning principles described in FIG. 9 is represented by exhaust air 15e continuing to flow inside engine housing 905 surrounding the expander rotary turbomachinery 10 and 907 and the stationary turbomachinery 10a and 906 respectively, wherein exhaust air 15e undergoes a second expansion through expander 907 coupled to shaft 1205 to convert the thermal energy of exhaust air 15e to mechanical energy by rotating shaft 1205 coupled to generator 12 for the conversion of shaft 1205 rotary energy into electricity distributed by power bus 18.

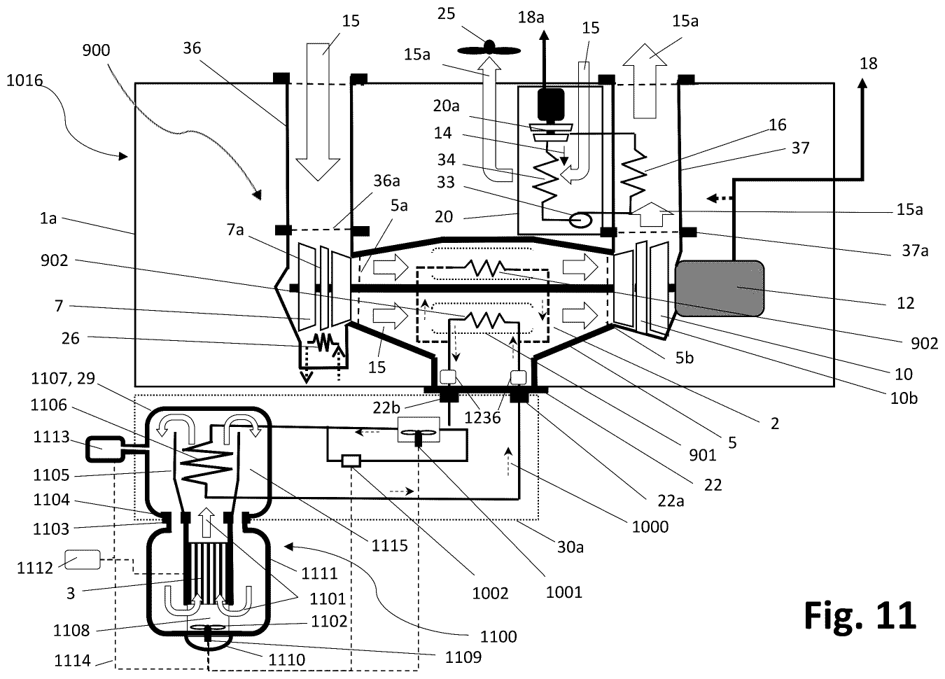

FIG. 11 describes the same functioning principles described for the power system formed by engine 900 and 1003 coupled to a heat source shown in FIGS. 9 and 10 with exception on the type of working fluid circulating in the thermodynamic intermediary system 30a. In the configuration shown in FIG. 11, the working fluid cooling the nuclear core 3 is in a gaseous form. Accordingly, for gaseous working fluid 1101 to circulate through heat exchanger 901 of engine 1003, a recirculator fan 1102 replaces pump 38 in FIG. 9 and eliminates the need for pressurizer 39 also shown in FIG. 9.

As working fluid 1101 inlets the nuclear core representing heat source 3 at inlet 1108, thermal energy is added to it prior to entering the internal reactor shroud 1105, including the intermediary heat exchanger 1106 enabling transferring of thermal energy to the working fluid 1101 circulating internally to the intermediary heat exchanger 1106, included within the pressure boundary represented by the top pressure vessel 1107 and the reactor pressure vessel 1111. As the working fluid 1101 flows through the intermediary heat exchanger 1106 it inverts its flow direction and recirculates back through a channel or gap 1115 formed by the outer walls of reactor shroud 1105 and the inner walls of top pressure vessel 1107. Under the driving effect of recirculating fan or pump 1102 into inlet 1108 of heat source 3, working fluid 1101 resets its cycle and starts to flow into heat source 3 again. This configuration enables passive cooling of heat source 3 as working fluid 1101 can circulate through heat source 3, exchange thermal energy with the intermediary heat exchanger 1106, thus cooling down, flow into gap 1115 and circulate back into heat source 3 in the same manner as described when undergoing the driving force of fan or pump 1102. In fact, should fan or pump 1102 fail to operate, working fluid 1101 recirculates naturally and cools down heat source 3 due to gravity driven buoyancy differential. As part of the control system for the regulation of the thermal power transferred from heat source 3 to heat exchanger 1106, the heat source controller 1112 regulates motor 1109 by changing the speed of fan or pump 1102, which subsequently varies the flow rate of working fluid 1101 through heat source 3 and heat exchanger 1106. As the flow rate of working fluid 1101 varies, the thermal transfer rate between the heat source 3 and the intermediary heat exchanger 1106 varies proportionally, which, in turn varies the thermal power transferred to source heat exchanger 2. For configurations wherein the heat source 3 is represented by a nuclear core, controller 1112 regulates the core reactivity (e.g., by changing the position of neutron absorbing materials actuated by the controlled movement of mechanisms such as control rods, control drums, internal or external to the nuclear core representing heat source 2 (these reactivity control mechanisms and actuators are not shown in FIG. 11). For configurations wherein working fluid 1101 is in a gaseous form, among the controller 1112 functions, the inventory of working fluid 1101 may be regulated by introducing or extracting working fluid 1101 inventory, for example and not shown in FIG. 11, to increase or decrease its density by actuating valves to opening or closing working fluid reservoir 1113. The working fluid reservoir 1113 is coupled via ports to a compressor and pressurized tanks to replenishing working fluid 1101, or to increase or decrease its density by increasing or decreasing its compression. Changing the working fluid energy transfer is also obtained by controller 1113 by varying the speed of motor 1109 driving the fan or impeller 1102. Controller 1113 actuates these changes electro-mechanically and/or pneumatically through the control, motive force pneumatic tubing and data cables 1114. Overall, the heat source 3 can vary its thermal power rate based on the engine 900 and generator 12 power demand, through the thermodynamic system 30a, and, or directly, by impacting the thermal power rate demand required by heat exchanger 901. In other words, the electric power rate at the electric power bus 18 follows the user electric demand and dictates the thermal-loading required by the source heat exchanger 901, which, in turns, drives the thermal power rate of the gas-cooled reactor system 1100 regulated by controller 1112. This mode of operation of the combined engine 900 and gas-cooled reactor system 1100 is referred to as “load-following”. Motor 1109 may be configured to operate within the pressure boundary of the reactor pressure vessel 1111 by equalizing the pressure within bottom pressure vessel 1110 with the pressure within reactor pressure vessel 1111. In another configuration, motor 1109 and fan 1102 are equipped with seals between their rotary and stationary components (not shown in FIG. 11), and the pressure boundary represented by bottom pressure vessel 1110 with respect to the pressure within the reactor pressure vessel 1111 may be different. For example, in one configuration, the cavity formed by motor 1109 housing and bottom pressure vessel 1110 may be at low pressure or a vacuum. In another configuration, the cavity formed by motor 1109 housing and bottom pressure vessel 1110 may be at high pressure with the same working fluid 1101. In yet another configuration, the cavity formed by motor 1109 housing and bottom pressure vessel 1110 may be at high pressure with a fluid different from working fluid 1101 (e.g., to detect leakages).

FIG. 12a illustrates a symmetrical cross-sectional view of the main components forming combustor system 1203, the low-pressure compressor turbomachinery 1206, the high-pressure compressor turbomachinery 1207, the expander turbomachinery 1213 of a commercial aeroderivative 1200. In the functional diagram of FIG. 12a, air 1208 inlets the multi-stage low-pressure compressor turbomachinery 1206 and the multi-stage high-pressure compressor 1207 following the functionality of traditional turbojet engines. As compressed air 1208 exits the high-pressure stages of compressor 1207, it enters the internal jacket 1214 formed by the combustor pressure vessel 1204 and the combustion chamber walls 1209 of combustor system 1203 (these types of combustors are often referred to as “bucket combustors” or “turbine bucket” and can be positioned substantially coaxially with respect to shaft 1205, or in a radial-stellar configuration as shown in FIGS. 27 and 28). As compressed air enters the combustion chamber wall 1209 through access holes showed by the dashed lines, it mixes with fossil-fuel 1211 (e.g., methane gas, propane gas, jet fuel, particulate fuel), injected by injector 1210 and sprayed within combustion chamber 1209 to mix with air entering combustion chamber 1209 from multiple access holes to ignite and produce high-temperature combustion gases 1212 that expand through expander 1213 and convert thermal energy into shaft work at shaft 1205 (the illustration in FIGS. 12a and 12 show ½ of the shaft and turbomachinery components as the missing ½ is symmetrical). Exhaust gases 1212 are discharged at outlet 1215, through outlet aeroderivative casing 1219. In one configuration, exhaust combustion gases 1212 can drive a secondary turbine coupled to an electric generator to produce electricity. In another configuration, shaft 1205 can be coupled directly, or indirectly (e.g., via gear box), to electric generator 12.

FIG. 12 illustrates a commercial engine based on an aeroderivative coupled to a generator 12 with the same components described in FIG. 12a. In FIG. 12, commercial engine 1200 is configured with combustor housing 1204 that develops axially and radially with respect to shaft 1205. In this manner, the combustor housing 1204 can scale up its dimensions without impacting the length of shaft 1205.

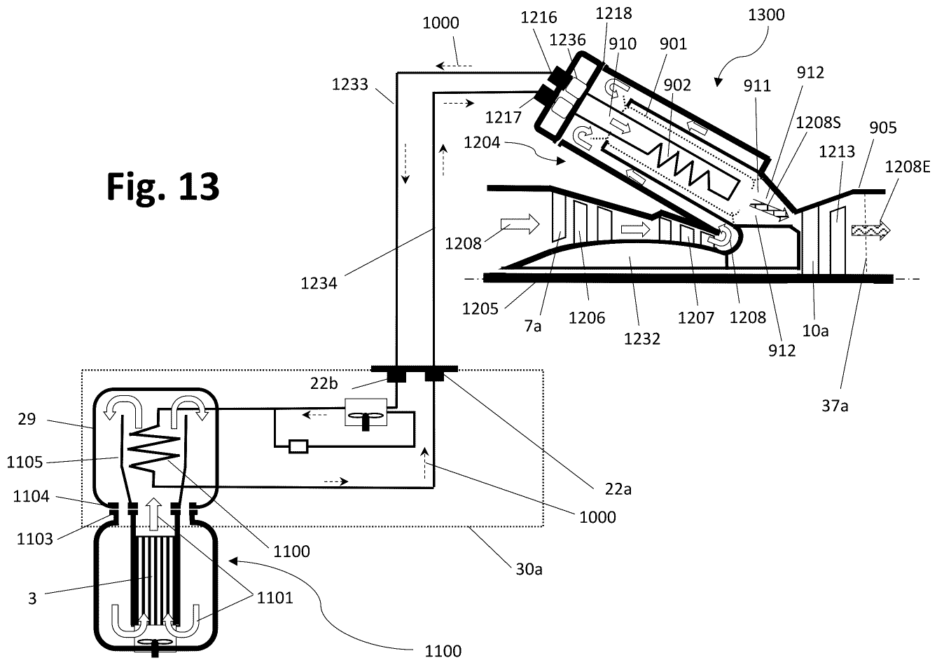

FIG. 13 illustrates the cross-sectional view of a retrofitted combustor housing 1204, wherein heat exchanger 901 is disposed within the inner space 912 formed within the engine housing 905 including the engine chamber 913 developed with a more convoluted geometry with respect to the representations shown in FIGS. 9 and 10. In FIG. 13, the fossil fuel tubing 1211 and fuel injection components 1210 along with the combustion chamber 1209 are replaced by heat exchanger 901 in a manner that compressed air 1208 flows through heat exchanger 901, and is thermally coupled to the surfaces 902 of heat exchanger 901 for air 1208 to become superheated air 12085 with increased thermal energy to be conditioned by stator turbomachinery 10a and expand through the single or multi-stage expander turbomachinery 1213 to exit through outlet engine casing 905 at outlet 37a as exhaust air 1208E. As superheated air 1208S expands through expander 1213, it converts thermal energy into mechanical energy transferred to shaft 1205 mechanically coupled, and driving, the low- and high-pressure compressor 1206 and 1207 respectively.

In an exemplary configuration consistent with the present invention, the retrofitting of a commercial engine as that shown in FIG. 12, consists of replacing the internal components of combustor system 1203 (FIG. 12) with the components forming heat exchanger 901 along with the adoption of high-pressure reversible inlet and outlet ports 1216 and 1217 (e.g., the flow direction of working fluid 1000 can be reversed by reversing the inlet and outlet ports 1216 and 1217), hydraulically interfacing engine housing 905 with the inner space 912 and the hydraulic headers 1236 of heat exchanger 901. Outlet and inlet ports 1216 and 1217 hydraulically couple thermal-insulated high-pressure tubing 1233 and 1234 circulating working fluid 1000 through pressure flange 1218 into and out of heat exchanger 901 without mixing working fluid 1000 with air 1208.

While the present invention is described herein with reference to illustrative embodiments for particular applications, it should be understood that the invention is not limited thereto. The preceding description of the disclosed embodiments is provided to enable any person skilled in the art to make or use the claims. Various modifications to these embodiments will be readily apparent to those skilled in the art, and the generic principles defined herein may be applied to other embodiments and implementations.

What is claimed is:

1. A power system, comprising:
an engine including an engine housing, and a compressor and an expander mechanically coupled together through a rotating shaft, wherein an inner space of the engine housing defines an engine chamber;
a heat exchanger disposed inside the engine chamber, wherein the heat exchanger is configured to heat up an air flow compressed into the engine chamber by the compressor, and wherein the heated air flow drives the expander to rotate; and
a generator coupled with the expander and configured to generate electricity based on mechanical energy provided by the expander.

2. The power system of claim 1, wherein the generator is mechanically and directly coupled with the expander through the shaft.

3. The power system of claim 1, wherein the shaft is a first shaft, and the expander is a first expander, the power system further comprises a second shaft and a second expander, wherein the second expander is mechanically and directly coupled with the generator through the second shaft, and the second expander is fluidly coupled with the first expander through the heated air flow.

4. The power system of claim 1, wherein the heat exchanger is disposed inside a portion of the engine chamber outside of a combustion chamber in which a combustor is disposed.

5. The power system of claim 1, wherein the heat exchanger is disposed inside a combustion housing that is a part of the engine housing, and wherein a combustor of the engine originally disposed in the combustion housing has been removed and replaced by the heat exchanger.

6. The power system of claim 1, wherein the heat exchanger is disposed at a center portion of the engine chamber and the shaft extends throughout a center portion of the heat exchanger.

7. A power system, comprising:
an engine including an engine housing, and a compressor and an expander mechanically coupled together through a rotating shaft;
a heat exchanger disposed in a heating chamber, wherein the heating chamber is disposed external to the engine, and is fluidly coupled with the engine housing through conduits, and wherein the heating chamber is configured to receive an air flow from the engine housing through the conduits, and wherein the heat exchanger heats up the air flow, and the heated air flow flows back into the engine housing through the conduits to drive the expander to rotate; and
a generator coupled with the expander and configured to generate electricity based on mechanical energy provided by the expander.

8. The power system of claim 7, further comprising a nuclear reactor heat source, wherein the heat exchanger is fluidly coupled with the nuclear reactor heat source, and the heating chamber is external to a pressure vessel in which the nuclear reactor heat source is disposed.

9. The power system of claim 7, further comprising a nuclear reactor heat source, wherein the heating chamber is a part of a pressure vessel in which the nuclear reactor heat source is disposed.
